(19) United States
(12) Patent Application Publication
(10) Pub. No.: US 2025/0382747 A1
(43) Pub. Date: Dec. 18, 2025

(54) Surface section of fibrous material, method for producing a surface section and method for producing three-dimensional molded parts from a surface section

(71) Applicant: Kiefel GmbH, Freilassing (DE)

(72) Inventors: Cornelis Hendrikus Albertinus Decoz, Sprang-Capelle (NL); Josef Strasser, Staudach-Egerndach (DE)

(21) Appl. No.: 19/240,144

(22) Filed: Jun. 17, 2025

(30) Foreign Application Priority Data
Jun. 18, 2024 (DE) 10 2024 117 134.0

(51) Int. Cl. D21J 3/00

(52) U.S. Cl. CPC D21J 3/00

(57) ABSTRACT

A surface portion made of fibrous material for processing into a three-dimensional molded part by a forming process, a method for producing a surface portion made of fibrous material for processing into a three-dimensional molded part by a forming process, and a method for producing three-dimensional molded parts from a surface portion made of fibrous material are described. The degree of forming of surface portions can be significantly increased by means of a defined separation of the fibrous material before the forming.

### PRIORITY CLAIM

The present application claims priority under 35 U.S.C. § 119 to German Patent Application No. DE 10 2024 117 134.0, filed Jun. 18, 2024, the disclosure of which is incorporated by reference herein in its entirety.

### TECHNICAL FIELD

A surface portion made of fibrous material for processing into a three-dimensional molded part by a forming process, a method for producing a surface portion made of fibrous material for processing into a three-dimensional molded part by a forming process, and a method for producing three-dimensional molded parts from a surface portion made of fibrous material are described.

### BACKGROUND

Surface portions made of fibrous material can be formed into three-dimensional molded parts, such as packaging for food (e.g., bowls, capsules, boxes, lids, etc.) and consumer goods (e.g., electronic devices, etc.), in a forming process under pressure and temperature. Everyday items, such as disposable cutlery and tableware, can also be made from fibrous material. Fibrous materials include natural fibers or artificial fibers, although recently there has been an increasing use of fibrous material that contains or consists essentially of natural fibers. These can be obtained, for example, from renewable raw materials or waste paper. Surface portions made of fibrous material can, for example, include at least one layer or ply of paper, cardboard, nonwoven or a nonwoven-like layer, such as a so-called airlaid or fluff pulp, compressed airlaid and others. Such materials have a relatively low moisture content of, for example, up to about 30 wt. % water.

However, the forming of the above-mentioned materials in a so-called dry thermoforming process is subject to significant restrictions with regard to the molding capacity due to the material properties of natural fibers in the dry state. Depending on the fibrous material used, the maximum elongation is about 2-15% relative to the initial state. Furthermore, fibrous material has poor flow behavior. This severely limits the range of possible product geometries (depth, ribs, undercuts, draft angles <10°, etc.) for products made from a fibrous material. Paper in particular can only be deformed to a very limited extent, as it begins to tear easily when deformed.

The manufacture of products from a fibrous material is known, for example, from WO 2017/160218 A1, which is incorporated by reference as if fully set forth herein.

When producing molded parts using dry fiber thermoforming, it is often necessary to draw in the material surrounding the mold, as the extensibility of the material is usually not sufficient. This applies to paper as well as airlaid, kraft paper or similar materials made of natural fibers. In particular, if a plurality of products or molded parts are to be formed from a sheet or web at the same time, they must first be cut/punched out of the sheet or web (pre-cutting). However, this means that the cutout (blank), which is then formed into the molded part, is completely separated from the web or sheet. This has the consequence that the blank, or later the formed product, must be handled separately during further transport in a machine.

However, separate handling is very complex and involves high costs. In addition, the individual removal of molded parts is at the expense of the production time, since the individual removal cannot work at the speed of, for example, a system for an endless feed (e.g., roller feed). Furthermore, the handling system must be moved in and out of a forming station, which requires a large investment in a separate and more complicated transport system. A further disadvantage is that the positioning of individual blanks or products is more difficult because the cutouts or products are no longer positioned by a web or sheet.

### SUMMARY

### Object

It is an object to provide a solution that eliminates the disadvantages of the prior art and enables the forming of surface portions made of fibrous material, where no separation of blanks from a surface portion is necessary and, in addition, high mold heights can be realized during production, so that there are substantially no restrictions with regard to the mold depth and product geometry when producing three-dimensional molded parts in a “dry fiber” processing method.

### Solution

The above-mentioned object is achieved by a surface portion made of fibrous material for processing into a three-dimensional molded part by a forming process, where the surface portion has at least one material layer, where the surface portion has at least one molding region for forming to produce a three-dimensional molded part and at least one first region and at least one second region, where the at least one first region and the at least one second region extend circumferentially together around at least a part of the at least one molding region, where the at least one first region has at least two portions in which the at least one material layer is completely separated, and the at least one second region has at least one portion in which the at least one material layer is completely separated, and where the two portions of the at least one first region are separated from one another via a first connecting region, where the first connecting region between the portions of the at least one first region is located relative to the portion of the at least one second region.

A surface portion can be provided by an endless material web or a sheet of material. The at least one molding region within the surface portion can remain for example in an endless material web or a sheet of material, and can be transported via this, through the portions of the at least one first region and the at least one second region, even during forming and after forming with the remaining surface portion, so that on the one hand no separate transport of individual blanks or molded parts is required and on the other hand the position of the blanks or molded parts, which are formed in the molding region, is maintained along the transport route.

In the portions, the material of the surface portion is separated, so that when the molding region is reshaped, a “pulling in” of the fibrous material leads to a compensating movement in that the portions are widened, where a connection in the form of strips or the like exists between an edge of the molding region or the molded part and a part of the surface portion surrounding the first region. By forming and drawing in material in the molding region, for example, at least two strips can be formed that extend from at least one connecting region between the portions of the first region to second connecting regions on the molding region.

The arrangement of the first connecting region between the portions of the at least one first region relative to the portion of the at least one second region allows compensation depending on the requirements and geometry of the molded part to be produced. For example, the portions of the first connecting region can form strips of different lengths that have a common base in the connecting region, so that the other ends of the strips connected to the molding region are differently displaced and positioned when forming takes place.

In further embodiments, the first connecting region between the portions of the at least one first region can be located substantially centrally relative to the portion of the at least one second region, so that strips of substantially equal length are formed. Such embodiments can be intended, for example, for the production of rotationally symmetrical molded parts.

In one embodiment, for example, a compensating movement of the material can be carried out only for a part of a molding region by separating the fibrous material into two regions, as described above. In further embodiments, first and second regions can have a plurality of portions, so that there exists a plurality of first connecting regions in the first region and second connecting regions in the second region. This makes it possible, for example, to provide compensation in the material around the entire molding region during forming, where the drawing in in the molding region is substantially compensated by an enlargement between the first region and the second region, without the part of the surface portion surrounding the first region being deformed or drawn in, and where the position of the molding region or molded part is substantially maintained.

In still further embodiments, at least one third region can also be provided, which is connected to the second region and the molding region according to the pattern described above, so that forming of the molding region is compensated by a compensation between the regions.

This allows particularly large mold heights to be realized since, depending on the design of the regions, a strong drawing in of material in the molding region can be achieved without the surface portion outside the molding region and the first or second region being drawn in or deformed.

In further embodiments, a length of the portion of the at least one second region can be greater than a length of the portions of the at least one first region. Such embodiments can, for example, take into account a special forming in the molding region, where locally stronger shaping is required compared to neighboring areas.

In further embodiments, the surface portion can have a substantially planar extent. This allows the surface portion to be easily transported and fed to various processing stations.

In further embodiments, the at least one first region and the at least one second region can run substantially parallel to one another. This allows defined strips or connecting elements to be formed between the first region and the molding region after forming, due to the compensation.

In further embodiments, the at least one first region and the at least one second region can completely surround the molding region, where a drawing in of material during forming in the molding region is taken into account, and where no drawing in occurs in the surface portion, even when there is a plurality of molding regions, so that the position of the molding regions is maintained throughout the entire production process.

In further embodiments, a length of the portion of the at least one second region can be substantially 1.5 to 2.5 times a length of the portions of the at least one first region.

In further embodiments, the at least one first region can have circumferential portions that are each separated from one another via a first connecting region, where the at least one second region has circumferential portions that are each separated from one another via a second connecting region. This allows compensation to be provided in any direction during forming.

In further embodiments, the first connecting regions can be located substantially centrally relative to the portions of the at least one second region and the second connecting regions can be located substantially centrally relative to the portions of the at least one first region. This allows compensation to be achieved via the resulting “strips,” where the load in the fibrous material is uniformly distributed.

In further embodiments, the at least one molding region can have a three-dimensional molded part after forming and an edge of the three-dimensional molded part can be connected to a material surrounding the at least one first region via at least two strips, where the strips are formed from the material that is located between the portions of the first region and the second region before the forming.

In further embodiments, the at least one first region and the at least one second region can be aligned according to a degree of forming during the forming to form the three-dimensional molded part, where the at least one first region and the at least one second region can extend, for example, substantially circularly, ovally or polygonally. In further embodiments, the distance of the at least one first region and/or the at least one second region to a center point of the molding surface can remain the same or can vary.

The above-mentioned object is also achieved by a method for producing a surface portion made of fibrous material for processing into a three-dimensional molded part by a forming process, where the surface portion has at least one material layer, including the following steps:
providing at least one surface portion made of fibrous material, and
separating the fibrous material into at least one first region and into at least one second region, where the at least one first region has at least two portions and the at least one second region has at least one portion, where the two portions of the at least one first region are separated from one another via a first connecting region.

The separation of the portions in the at least one first region and the at least one second region enables the formation of surface portions with preferably a plurality of molding regions, where the molding regions in the at least one first region and at least one second region are each separated from the remaining surface portion by the portions and remain connected after forming by connecting elements or strips formed therebetween.

The separation can be carried out, for example, by punching with appropriate punching knives in a punching station that is located upstream of a forming station. In further embodiments, a station can have a combined tool for punching and forming, where the tool is designed such that during a closing movement, the portions are first punched and during the further movement, the forming process is initiated. This also makes it easier to align the molding regions and molded parts, as the molding regions are no longer displaced relative to the tool after punching.

The method enables the formation of molded bodies with large mold depths (e.g., large mold heights) and, at the same time, easy transport of the surface portion, whether as a web or sheet, where the positioning of molding regions, blanks and molded parts can be maintained across multiple stations and processing steps.

Furthermore, the advantages described above with regard to the surface portion also occur in a corresponding manner in the method for producing such surface portions.

Furthermore, the above-mentioned object is also achieved by a method for producing three-dimensional molded parts from a surface portion of fibrous material according to one of the embodiments described above, including the following steps:
providing a surface portion made of fibrous material with at least one material layer, including at least one molding region and at least one first region and at least one second region, where the at least one first region and the at least one second region extend circumferentially together around at least a part of the at least one molding region, where the at least one first region has at least two portions in which the at least one material layer is completely separated, and the at least one second region has at least one portion in which the at least one material layer is completely separated, and where the two portions of the at least one first region are separated from one another via a first connecting region, and
forming the molding region, where the fibrous material in the molding region is deformed at least locally three-dimensionally from a substantially planar extent to form a molded part, where the distance between the at least two portions of the at least one first region and the at least one portion of the at least one second region is increased and at least one free space is created between the first connecting region and an edge of the molded part.

The method for producing three-dimensional molded parts enables molded parts to be formed from a surface portion which, with regard to their shape, do not exhibit any deviations from the shape specifications or from one another, because the position and alignment of molding regions can be maintained and ensured throughout the entire manufacturing process. In addition, it is possible to form molded parts with more complex product geometries from a surface portion.

The above embodiments for a surface portion and a method for producing surface portions apply correspondingly to the method for producing three-dimensional molded parts from a surface portion.

Further features, embodiments and advantages result from the following illustration of exemplary embodiments with reference to the figures.

### BRIEF DESCRIPTION OF THE FIGURES

In the figures:

FIG. 1 depicts a schematic representation of a surface portion made of fibrous material for the production of three-dimensional molded parts after a punching step;

FIG. 2 depicts a schematic representation of the surface portion from FIG. 1 after a forming step;

FIG. 3 depicts a schematic representation of a surface portion made of fibrous material for the production of three-dimensional molded parts after a punching step with a plurality of molding regions;

FIG. 4 depicts a schematic representation of the surface portion from FIG. 3 after a forming step;

FIG. 5 depicts a schematic representation of a method for producing three-dimensional molded parts from a surface portion made of a fibrous material; and

FIG. 6 depicts a schematic representation of a cutout of a forming tool during the forming of fibrous material.

### DETAILED DESCRIPTION

Various embodiments of the technical teaching described herein are shown below with reference to the figures. Identical reference signs are used in the figure description for identical components, parts and processes. Components, parts and processes that are not essential to the technical teachings disclosed herein or that are obvious to a person skilled in the art are not explicitly reproduced. Features specified in the singular also include the plural unless explicitly stated otherwise. This applies in particular to statements such as “a” or “one.”

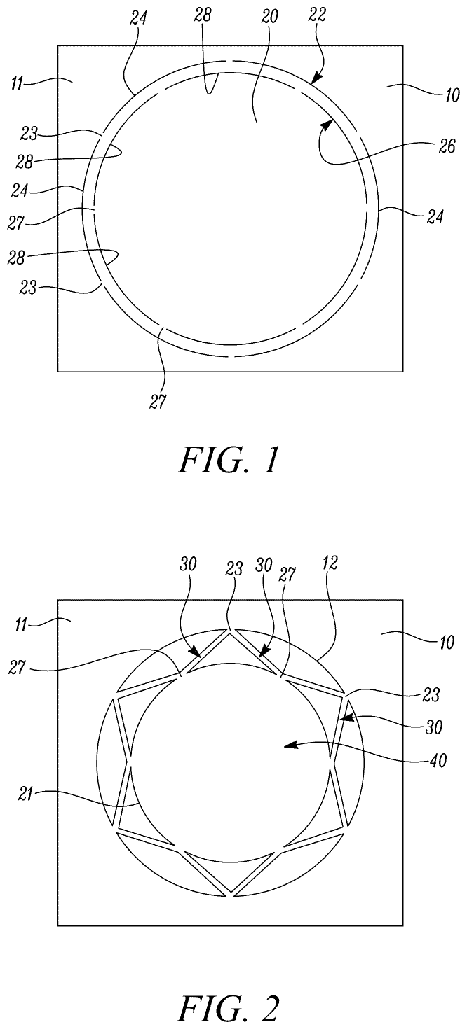

FIG. 1 shows a schematic representation of a surface portion 10 made of fibrous material, which can be used as starting material for the production of three-dimensional molded parts 40. The fibrous material is a relatively dry material made of fibers, with the fibers preferably being of natural origin. This includes, in particular but not exclusively, cellulose fibers. The moisture content of the fibrous material can be for example between 3 and 40, preferably between 5 and 30, more preferably between 7 and 20 wt. % water. The fibrous material or the surface portion 10 can have at least one ply or layer of an airlaid, a paper (e.g., kraft paper, crepe, etc.), a fluff pulp or another substantially nonwoven-like layer. In further embodiments, the surface portion 10 or the fibrous material may have additives and/or a coating in order to achieve specifiable properties (barrier, mechanical properties, coloring, etc.).

The surface portion 10 can be fed for later processing as an endless web from a roll or as a sheet, where the feeding and dimensions of the surface portion 10 can in each case depend on the geometry of the molded parts 40 to be produced and the properties of the material.

In the embodiment shown, the surface portion 10 has a substantially uniform thickness, i.e., material thickness. The material thickness can be between 0.2 and 10 mm, depending on the number of layers and the material or design used.

In FIG. 1, a surface portion 10 is shown that has a molding region 20 that is separated from the remaining material by a first region 22 and a second region 26. The first region 22 has circumferentially uniform portions 24. In the portions 24, the fibrous material is completely cut through. Between the portions 24, the fibrous material has connecting elements 23 that act as connecting regions for the fibrous material between the molding region 20 and the remaining fibrous material. The connecting elements 23 act as a connection point after forming and must be designed and dimensioned depending on the degree of forming, the material used and the forces acting on the connecting regions. The second region 26 has circumferentially uniform portions 28. In portions 28, the fibrous material is completely cut through, as in the portions 24. Between the portions 28, the fibrous material also has connecting elements 27, which serve as connecting regions for the fibrous material between the molding region 20 and the remaining fibrous material. The connecting elements 27 act as a connection point after forming and must be designed and dimensioned depending on the degree of forming, the material used and the forces acting on the connecting regions.

The portions 24 and 28 run concentrically to each other and have a uniform spacing in the embodiment shown. In further embodiments (not shown), a first region 22 and a second region 26 can have portions that are not concentric with one another and/or only partially surround a molding region 20. In further embodiments, regions 22, 26 can surround a molding region 20 with varying distances or not in a ring-like manner, where portions 24, 28 can also be arranged ovally or polygonally. Likewise, in further embodiments molding regions 20 can have other planar extents, as shown in the figures.

The material of the surface portion 10, which surrounds the molding region 20 and in particular the first region 22, is not required for the forming of molded parts 40, and defines a holding region 11. The holding region 11 serves, on the one hand, to transport the surface portion 10 during production and to supply it to processing stations. Furthermore, the holding region 11 enables an exact positioning of molding regions 20 for forming, where, in particular when a plurality of molding regions 20 are formed simultaneously in a forming station, all molding regions 20 can assume a defined position and can also be introduced into and removed from the forming station together via a transport system. For example, a plurality of molding regions 20 can be precisely assigned to the cavities of a forming tool assigned to them.

During forming, the portions 24, 28 can provide compensation that allows the molding region 20 to be formed and to transition from a planar extent into a three-dimensional extent, where an edge 12 (see FIG. 2) is on the other hand not displaced. This means that the deformation or forming of the molding region 20 has no effect on the holding region 11. This makes it possible to maintain the position of all locations of the surface portion 10 with molding regions 20 even after forming, so that the molding regions 20 or molded parts 40 can be ejected together after forming and no individual removal is necessary. After the forming, the surface portion 10 can be removed from a forming tool together with a plurality of molded parts 40. The holding region 11 surrounding the molded parts 40 undergoes no, or only insignificant, deformation.

FIG. 2 shows a schematic representation of the surface portion 10 of FIG. 1 after a forming step, where due to the drawing in of fibrous material during forming, tabs 30 are formed that extend from connecting regions at the connecting elements 23 between portions 24 in the first region 22 to connecting regions at connecting elements 27 between portions 28 in the second region 26. The offset arrangement of the connecting elements 23 and 27 relative to one another enables a connection between the formed molding regions 20 or molded parts 40 and the holding region 11, where the position and orientation can be maintained because rotation of the molding regions 20 due to the drawing in of fibrous material is prevented. One reason for this is that there are multiple connection points between the molded part 40 or molding region 20 and the holding region 11, so that a displacement can only take place in one molding direction. In the embodiment shown, the material in the molding region 20 is pulled into the center to form a cup or bowl. Therefore, the drawing in of material is uniform and is laterally limited by the tabs 30 formed between the portions 24 and 18. The fibrous material of the tabs 30 can be stretched when there is further deformation. As a rule, the connecting elements 23 and 27 and thus the length of the portions 24 and 28 are arranged in the regions 22 and 26 in such a way that they are not subjected to heavy loads. The width of the connecting elements 23 and 27 as well as the distance between the portions 24 and 28 must also be determined according to the material used and the degree of forming.

For example, a fibrous material with a layer thickness of 0.2 to 10 mm with a diameter of the molding region 20 of 30 mm to 300 mm and a displacement of an edge 21 of the molding region 20 inwards, i.e., a distance between the edge 21 and the edge 12 after forming, that is for example in the range of 2 to 50 mm, can have connecting elements 23, 27 with a width of 1 to e.g., 100 mm and a width of the tabs 30 of 1 to 10 mm.

Differing from what is shown in the figures, molding regions 20 can also have other planar extents (e.g., oval, rectangular) and the formation of regions 22, 26 and the length of portions 24, 28 can vary. This applies in particular to the length of portions 24, 28 of a region 22, 26 in relation to one another.

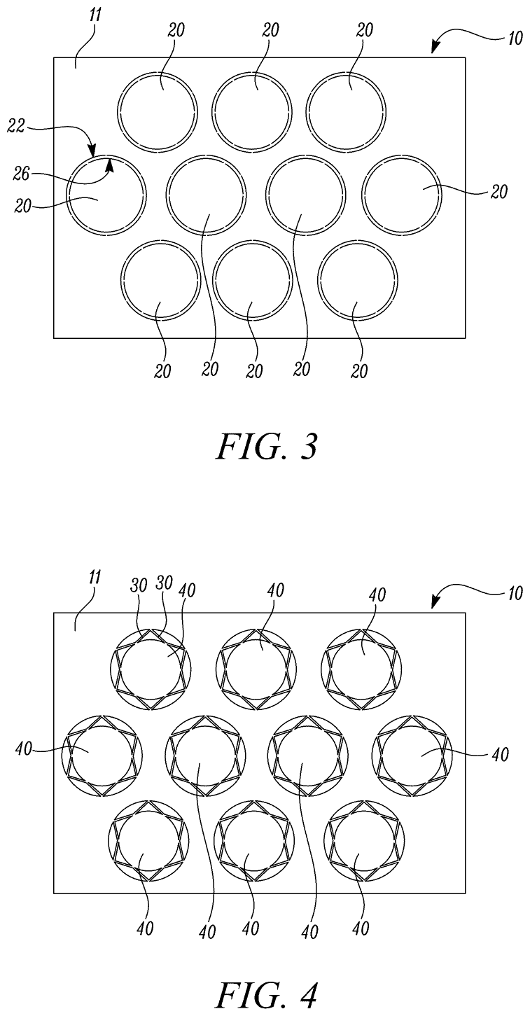

FIG. 3 shows a schematic representation of a surface portion 10 made of fibrous material for the production of three-dimensional molded parts 40 after a punching step with a plurality of molding regions 20. The surface portion 10 shown can represent a region that can be formed simultaneously in a forming tool. Such a forming tool has a tool table or a tool plate with a corresponding number of cavities and a corresponding tool part that presses the fibrous material of the molding regions 20 into the cavities while forming it.

The forming is usually carried out under high pressure in the range of 100 N/cm² to 10,000 N/cm², for example in the range of 400 N/cm² to 800 N/cm², and temperatures of 80° C. to 300° C., in particular at temperatures in the range of 120° C. to 250° C.

The cutting pattern shown for the individual regions corresponds to the embodiment shown in FIG. 1, but can differ from it in other embodiments, in particular if other molded parts are to be manufactured. In addition, in further embodiments, surface portions 10 can be formed with more or fewer molding regions 20.

The separation of portions 24, 28 is usually carried out in a step prior to the forming process, using a punching tool. In further embodiments, a tool can have both punching knives for punching or cutting through the portions 24, 28 and also forming tools (e.g., cavity and forming punch). When the tool is closed, the portions 24, 28 can first be cut through and then formed. For this purpose, the punching knives can, for example, protrude from a tool surface so that they first come into contact with the fibrous material and cause the fibrous material to be cut through in portions 24, 28. The punching knives can then be retracted mechanically, pneumatically or electrically so that when the tool halves are moved further, forming can take place without the punching knives protruding into the molding region of the tool for the forming.

FIG. 4 shows a schematic representation of the surface portion 10 from FIG. 3 after a forming step. Analogous to the representation of the surface portion 10 of FIG. 3, the position and the distance of the molded parts 40, as well as the spacing of edges 12 of the first regions 22 from one another, are shown in an exemplary embodiment. In further embodiments, the distance between the edges 12 can be significantly smaller, so that only one holding structure is provided. The distance to the edge regions of the surface portion 10 may also, in other embodiments, differ from that shown. It is also possible to increase the distances in order, for example, to provide a sufficiently large holding surface between the molded parts 40 or molding regions 20. The holding surface can be used to hold the surface portion 10 away from the molding regions 20 during forming, so that no drawing in of the fibrous material is possible. Therefore, the fibrous material in the holding region 11 is not deformed.

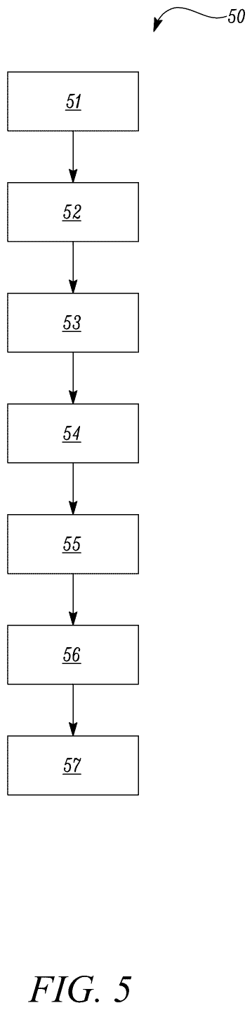

FIG. 5 shows a schematic representation of a method for producing three-dimensional molded parts 40 from a surface portion 10 made of a fibrous material.

In a first step, a surface portion 10 made of fibrous material is provided 51. The surface portion 10 can include, for example, kraft paper, airlaid, fluff pulp, crepe, nonwoven-like fiber material or other fibrous material. The fibrous material can in particular include at least one layer of such a material, as described above. In further embodiments, a fibrous material can be formed by a plurality of layers. Preferably, the fibrous material can include cellulose fibers.

The provision of the surface portion 10 can further include a step of producing the surface portion 10, where fibrous material is produced from a starting material (e.g., shredding and joining (e.g., airlaid)). The surface portion 10 can be provided as a sheet of material or an endless web, for example on a roll.

Subsequently, at least one surface portion 10 is introduced 52 or continuously or discontinuously transported (e.g., cyclically) into a punching station, where punching 53 of the surface portion 10 is carried out. Punching patterns can be introduced into the fibrous material, as described above in various embodiments. Punching patterns surround molding regions 20 for downstream forming 54 via at least one first region 22 and at least one second region 26, each having portions 24, 28. After punching 53, at least one surface portion 10 has completely cut-through portions 24, 28 in regions 22, 26. After punching 53, forming 54 takes place, where the previously punched surface portion 10 is formed either in a combined punching and forming tool or in a forming tool downstream of the punching station. During forming 54, molding regions 20 are formed, where the fibrous material is brought from its substantially planar extent into a three-dimensional shape via a forming tool 60. For this purpose, a compensating movement must be provided in the surface portion 10 due to the slipping or pulling of the fibrous material during forming. The compensating movement is achieved by loosening the fibrous material previously separated in the portions 24, 28. The connection between a holding region 11 of the fibrous material of the surface portion 10 and the molding region 20, which is formed into a molded part 40, remains only in connecting regions or connecting elements 23, 27, which are connected to one another via tabs 30. The tabs 30 allow a displacement of the molding region 20 without any compression, stretching or expansion of the fibrous material, in particular in the holding region 11, so that the position and orientation of all molding regions 20 in a forming tool for the simultaneous forming of a plurality of molding regions 20 in a surface portion 10 remains the same.

During forming 54, the fibrous material is formed only in the molding region 20 and pressed by the forming tool under high pressure and under the influence of temperature between molding surfaces in a cavity of the forming tool. Only the fibrous material in the molding region 20 can be partially compressed, stretched and extended.

Thereafter, the formed molding region 20 or the molded parts 40 are removed 55, where molded parts 40 of a surface portion 10 are removed 55 together. Advantageously, the holding region 11 is not formed or compressed or stretched, so that a feed does not have to take the forming into account. For example, a feed through the stations (at least punching, forming, etc.) of a molding installation can be carried out via rollers, grippers, tongs or clamps.

In further embodiments, further processing 56 can take place after the removal 55 or the forming 54. Further processing 56 can include for example printing, filling, coating, etc.

Finally, the molded parts 40 are separated 57 from the surface portion 10 in a further punching station using a punching tool, where the connection via the tabs 30 between the molded parts 40 and the holding region 11 is cut through. Preferably, the separation takes place in the connecting regions of the connecting elements 27, so that fiber material is prevented from protruding from the finished product. In still further embodiments, punching of an edge of the molded parts 40 can be carried out, where an outer peripheral edge region is completely separated.

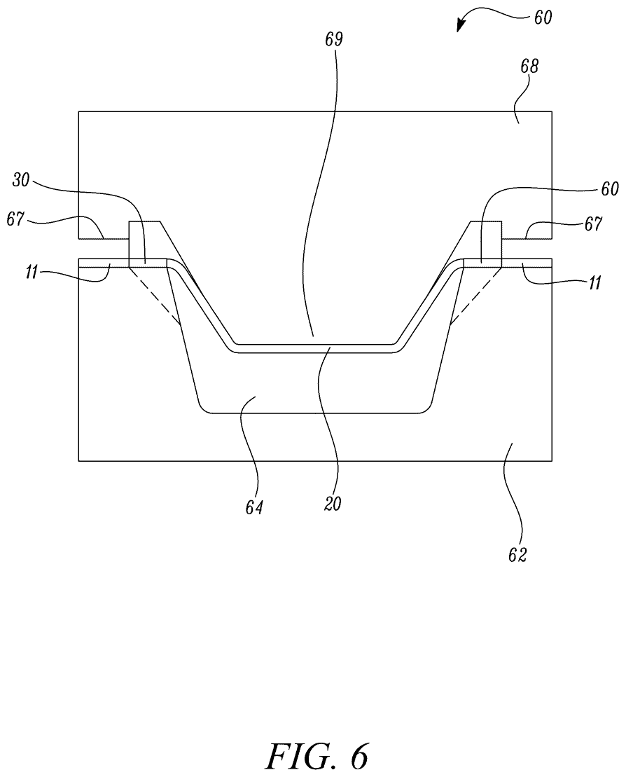

FIG. 6 shows a schematic representation of a cutout of a forming tool 60 during the forming of fibrous material. The forming tool 60 has a first lower tool part 62 with at least one cavity 64 and an upper second tool part 68 with a forming punch 69, where during the forming 54 the fibrous material is pressed between the molding surfaces of the cavity 64 and the forming punch 69. At least the upper tool part 68 or the lower tool part 62 can be heated via a heating device (not shown) in order to achieve or support a connection of the fibrous material when pressing the fibrous material for forming.

A forming tool 60 can in particular have a plurality of cavities 64 and corresponding forming punches 69, so that a plurality of molded parts 40 can be produced simultaneously in one pressing process.

In the exemplary representation, the upper tool part 68 has clamping regions 67 that serve to hold the fibrous material in holding regions 11 when the forming tool 60 is in the closed state, so that there is no displacement or deformation of the fibrous material there.

In the embodiment shown, the tabs 30 are located outside the cavity 64 when the forming tool 60 is closed and in the closed state of the forming tool 60. The tabs 30 are not clamped during the forming and closing of the forming tool 60, so that they can execute a compensating movement. In still further embodiments, cavities 64 can have regions for the tabs 30, as shown by the dashed lines.

The forming tool 60 can for example be installed in a fiber molding plant for producing three-dimensional products from a fibrous material, where the fiber molding plant can produce products that are biodegradable and can themselves serve as starting material for the production of three-dimensional molded parts 40 from a fibrous material and can be composted, because they can generally be completely decomposed and do not contain any harmful, environmentally hazardous substances. The molded parts 40 can be designed, for example, as cups, lids, bowls, capsules, plates and other molded and/or packaging parts (e.g., as holding/support structures for electronic or other devices). A fiber molding plant may have further stations and devices. For example, a supply of fiber-containing material can be provided. In further embodiments, a grinder can be provided for shredding a starting material and for separating fibers, which can then be further processed as surface portion 10.

The solution presented indicates how surface portions 10 can be pre-cut as a web or sheet in order to enable a virtually unhindered drawing in of material during forming, while at the same time blanks (molding region 20) or formed products (molded parts 40) can remain connected to the web or sheet.

### LIST OF REFERENCE SIGNS

10 Surface portion
11 Holding region
12 Edge
20 Molding region
21 Edge
22 First region
23 Connecting element
24 Portion
26 Second region
27 Connecting element
28 Portion
30 Tab
40 Molded part
50 Method
60 Forming tool
62 Tool part
64 Cavity
67 Clamping region
68 Tool part
69 Forming punch
51-57 Method steps

1. A surface portion made of fibrous material for processing into a three-dimensional molded part by a forming process, wherein the surface portion has at least one material layer, the at least one material layer comprising at least one molding region for producing a three-dimensional molded part and at least one first region and at least one second region, wherein the at least one first region and the at least one second region extend circumferentially together around at least a part of the at least one molding region, wherein the at least one first region has at least two portions in which the at least one material layer is completely separated, and the at least one second region has at least one portion in which the at least one material layer is completely separated, and wherein the at least two portions of the at least one first region are separated from one another via a first connecting region, wherein the first connecting region between the at least two portions of the at least one first region is located relative to the at least one portion of the at least one second region.

2. The surface portion according to claim 1, wherein a length of the at least one portion of the at least one second region is greater than a length of the at least two portions of the at least one first region.

3. The surface portion according to claim 1, wherein the surface portion has a substantially planar extent.

4. The surface portion according to claim 1, wherein the at least one first region and the at least one second region run substantially parallel to one another.

5. The surface portion according to claim 1, wherein the at least one first region and the at least one second region completely surround the at least one molding region.

6. The surface portion according to claim 1, wherein a length of the at least one portion of the at least one second region is approximately 1.5 to 2.5 times a length of the at least two portions of the at least one first region.

7. The surface portion according to claim 1, wherein the at least two portions of the at least one first region are circumferential portions that are separated from one another via the first connecting region, and wherein the at least one second region has at least two circumferential portions that are separated from one another via a second connecting region.

8. The surface portion according to claim 7, wherein the first connecting region is located substantially centrally relative to the at least two circumferential portions of the at least one second region and the second connecting region is located substantially centrally relative to the at least two portions of the at least one first region.

9. The surface portion according to claim 1, wherein the at least one molding region has a three-dimensional molded part after the forming process and an edge of the three-dimensional molded part is connected to a material surrounding the at least one first region via at least two strips, wherein the strips are formed from the at least one material layer that is located between the at least two portions of the first region and the second region before the forming process.

10. The surface portion according to claim 9, wherein the at least one first region and the at least one second region are aligned in accordance with a degree of forming during the forming process to form the three-dimensional molded part.

11. A method for producing a surface portion made of fibrous material for processing into a three-dimensional molded part by a forming process, wherein the surface portion has at least one material layer, comprising:
providing at least one surface portion made of fibrous material, and
separating the fibrous material into at least one first region and into at least one second region, wherein the at least one first region has at least two portions and the at least one second region has at least one portion, wherein the at least two portions of the at least one first region are separated from one another via a first connecting region.

12. A method for producing three-dimensional molded parts from a surface portion of fibrous material comprising:
providing a surface portion made of fibrous material with at least one material layer, the at least one material layer comprising at least one molding region and at least one first region and at least one second region, wherein the at least one first region and the at least one second region extend circumferentially together around at least a part of the at least one molding region, wherein the at least one first region has at least two portions in which the at least one material layer is completely separated, and the at least one second region has at least one portion in which the at least one material layer is completely separated, and wherein the at least two portions of the at least one first region are separated from one another via a first connecting region, and
producing a molded part in the at least one molding region, wherein the fibrous material in the at least one molding region is deformed at least locally three-dimensionally from a substantially planar extent to form the molded part, wherein a distance between the at least two portions of the at least one first region and the at least one portion of the at least one second region is increased and at least one free space is created between the first connecting region and an edge of the molded part.
